(19) United States
(12) Patent Application Publication
(10) Pub. No.: US 2008/0106471 A1
(43) Pub. Date: May 8, 2008

(54) Compact PCB antenna

(75) Inventor: Ming-Hao Yeh, Zhubei City (TW)

Correspondence Address: REED SMITH LLP;ATTN: Juan Carlos A. Marquez, Suite 1400, 3110 Fairview Park Drive, Falls Church, VA, 22042, US

(73) Assignee: Media Tek Inc.

(21) Appl. No.: 11/593,553

(22) Filed: Nov. 7, 2006

(51) Int. Cl. H01Q 9/04; H01Q 1/38

(52) U.S. Cl. 343/700 MS

(57) ABSTRACT

A compact PCB antenna is disclosed. The compact PCB antenna has a substrate; a ground on the substrate; a radiating element patterned on the substrate; and a shorting path patterned on the substrate, the shorting path extends from a branch point of the radiating element; wherein the branch point defines a first section and a second section of the radiating element, and the first section has a feed pin at one end of the first section and the second section winds; and wherein the shorting path between the radiating element and the ground surrounds a part of the second section and connects to the ground.

### FIELD OF THE INVENTION

The invention is related to an antenna structure, and more particularly related to a compact PCB antenna for use in various applications, such as portable electronic communication device.

### BACKGROUND OF THE INVENTION

A portable electronic communication device, such as a personal digital assistant (PDA), a mobile phone, or a smart phone, requires an antenna to establish a wireless connection with another device in the communication system. In the telecommunication industry, multiple chip antennas are typically used in portable electronic communication devices integrated into Biuetooth, GPS or other functions. However, using chip antennas will increase the manufacturing cost, thus decrease the competitiveness of the portable electronic communication device. Further, the performance of a chip antenna is greatly affected by the surroundings. For example, the characteristics of the chip antenna, such as frequency band, input impedance, gain and the like, change from one printed circuit board (PCB) to another, which results in design complexity, because additional elements must be added to the antenna to achieve a good impedance matching.

Accordingly, PCB antennas are usually used to replace the chip antennas. Generally, there are two kinds of manners known in the art to design a compact PCB antenna, i.e. one is monopole antenna as shown in FIG. 1A and the other is inverted-F antenna as shown in FIG. 1B. The monopole antenna as shown in FIG. 1A has a transmission line extended a distance of about 1/4 wavelength over a ground to form a radiator, also called as a radiating element. The impedance matching for the monopole antenna may easily be made by adjusting the distance between the radiator and the ground plane. However, the manner of the monopole antenna will take up a lot of space, for example, the monopole antenna with 509 matching still requires a relatively long distance. Consequently, the monopole antenna is unsuitable for smallish electronic communication devices. On the other hand, the configuration of an inverted-F antenna is similar to the monopole antenna except that the inverted-F as shown in FIG. 1B one adds a short path to the ground. A short path is used to reduce the distance between the radiator and the ground plane described above.

Nevertheless, as portable electronic communication devices become smaller and smaller, even the conventional chip antennas, or monopole and inverted-F antennas are still too large to fit smallish portable electronic communication devices. The condition becomes even worse when the portable electronic communication devices need multiple antennas for multiple applications, e.g. cellular, GPS, Bluetooth and so forth.

Thus, there is a need for a compact PCB antenna capable of being employed in a small portable electronic communication device.

### SUMMARY OF THE INVENTION

One aspect of the present invention provides a compact PCB antenna, having a substrate; a ground on the substrate; a radiating element patterned on the substrate; and a shorting path patterned on the substrate, the shorting path extends from a branch point of the radiating element; wherein the branch point defines a first section and a second section of the radiating element, and the first section has a feed pin at one end of the first section and the second section winds; and wherein the shorting path between the radiating element and the ground surrounds a part of the second section and connects to the ground.

In one embodiment of the present invention, the substrate of the PCB antenna further comprises a plurality of layers and a via hole provided for extending the antenna on various layers of the substrate. As such, the antenna may further minify its size.

### BRIEF DESCRIPTION OF THE DRAWINGS

FIG. 1A shows a schematic diagram of a conventional structure of a monopole antenna.

FIG. 1B shows a schematic diagram of a conventional structure of an inverted-F antenna.

FIG. 2 shows a top view of a compact PCB antenna in accordance with one embodiment of the present invention.

FIG. 3 shows a curve of the simulation and experimental result of the compact PCB antenna illustrated in FIG. 2.

FIG. 4 shows a top view of a compact PCB antenna in accordance with another embodiment of the present invention.

FIG. 5 shows a top view of a compact PCB antenna in accordance with another embodiment of the present invention.

FIG. 6 shows a top view of a compact PCB antenna in accordance with one embodiment of the present invention.

FIG. 7 shows a top view of a compact PCB antenna in accordance with another embodiment of the present invention.

FIG. 8 shows a perspective view of a compact PCB antenna that extends on various layer of the substrate in accordance with one embodiment of the present invention.

FIG. 9 shows a perspective view of a compact PCB antenna that extends on various layer of the substrate in accordance with another embodiment of the present invention.

FIG. 10 shows a curve of the experimental result of the compact PCB antenna illustrated in FIG. 9.

FIG. 11 shows a perspective view of a compact PCB antenna that extends on various layer of the substrate in accordance with another embodiment of the present invention.

FIG. 12 shows a curve of the experimental result of the compact PCB antenna illustrated in FIG. 11.

FIG. 13 shows a top view of a compact PCB antenna that extends on various layer of the substrate in accordance with one embodiment of the present invention.

FIG. 14 shows a curve of the experimental result of the compact PCB antenna illustrated in FIG. 13.

FIG. 15 shows a top view of a compact PCB antenna that extends on various layer of the substrate in accordance with one embodiment of the present invention.

FIG. 16 shows a curve of the experimental result of the compact PCB antenna illustrated in FIG. 15.

FIG. 17 shows a schematic diagram of a compact PCB antenna that extends on various layer of the substrate in accordance with one embodiment of the present invention.

FIG. 18 shows a curve of the experimental result of the compact PCB antenna illustrated in FIG. 17.

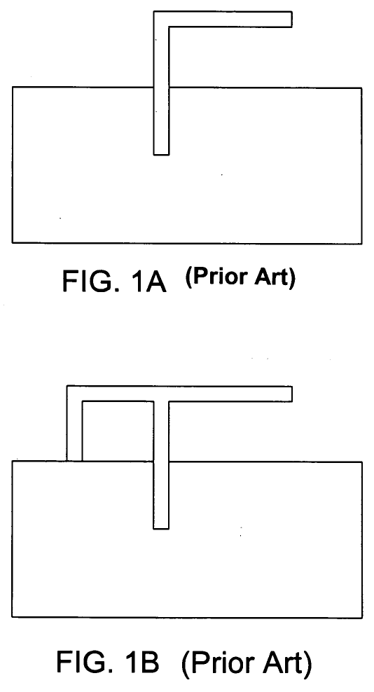

### DETAILED DESCRIPTION

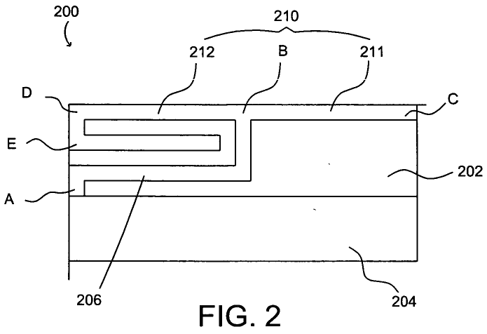

A compact PCB antenna is disclosed. In the following, the present invention can be further understood by referring to the exemplary, but not limiting, description accompanied with the drawings in FIG. 2 to FIG. 18.

Now referring to drawings, FIG. 2 is a top view showing a compact PCB antenna 200 in accordance with one embodiment of the present invention. The compact PCB antenna 200 includes a substrate 202, such as FR4, FR408, or Rogers 4003 as known to those skilled in the art, a radiating element 210 patterned on the substrate 202, a ground 204 on the substrate 202, and a shorting path 206 patterned on the substrate 202. One end of the shorting path 206 is electrically connected to the ground 204 at point A and the other end of the shorting path 206 is electrically connected to the radiating element 210 at a branch point, namely point B. The point B defines a first section 211 and a second section 212 of the radiating element 210. The first section 211 has a feed pin at one end of the first section 211, i.e. point C, and the second section 212 winds. In this embodiment, the second section 212 has two turns at point D and point E. The shorting path 206 between the radiating element 210 and the ground 204 surrounds a part of the second section 212. It should be noted that though the second section 212 in this embodiment has only two turns, there can be more turns in other embodiments. In addition, though each of the two turns makes a 90-degree angle, it can be any degree angle in other embodiments, that is, the term “turn” herein means changing the direction and does not intend to mean turning a right angle.

It should also be noted that the shorting path 206 surrounds the second section 212 from point E to the end of the second section 212 as shown in FIG. 2. However a shorting path of an antenna in another embodiment may surround “any part” of a second section of the antenna, and preferably surround a part of the second section that minimizes the size of the antenna.

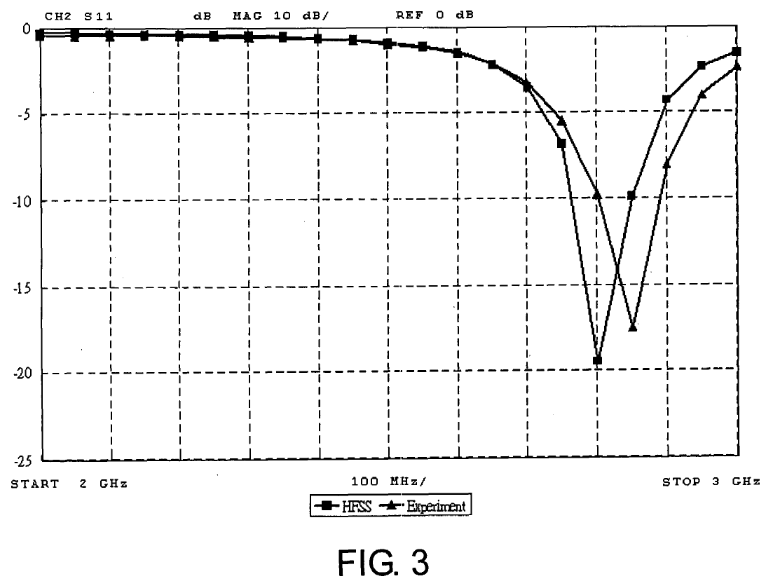

The distance between the radiating element 210 and the ground 206 can be efficiently reduced by making the shorting path 206 extend between the radiating element 210 and the ground 204 from point A and then connect to the ground 204 so as to surround a part of the second section 212. FIG. 3 shows a curve of the simulation and experimental result of the compact PCB antenna that has a size of 3 mm×20 mm illustrated in FIG. 2. From the result, the bandwidth of the compact PCB antenna may be 70 MHz with its Return Loss less than −10 dB.

In another embodiment as shown in FIG. 4, the structure of a compact PCB antenna 400 is similar to the compact PCB antenna 200, except that one end of the second section 212 described above is connected to a metal plane 413. Specifically, the second section 212 is ended with the metal plane 413. The resulting structure may be of 4.5 mm×12 mm in size and the simulation and experimental data show that it has a bandwidth about 80 MHz with its Return Loss less than −10 dB.

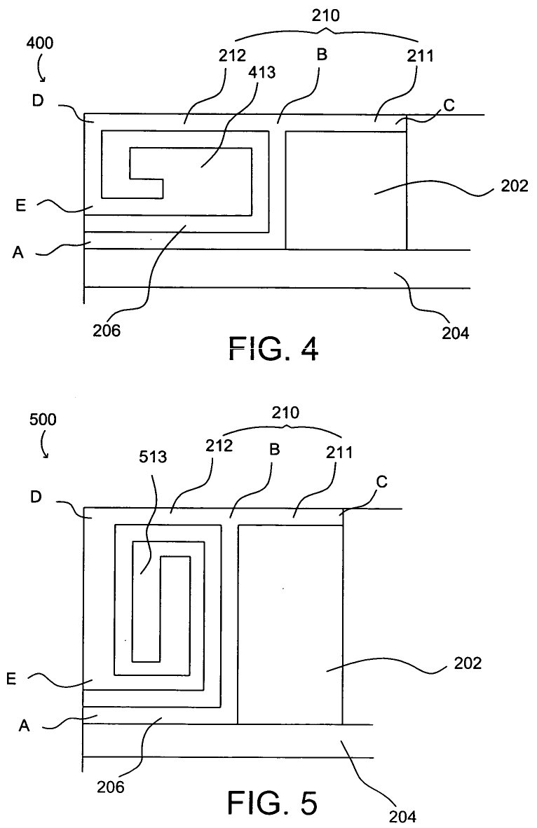

In yet another embodiment of the present invention as shown in FIG. 5, the structure of a compact PCB antenna 500 is similar to the compact PCB antenna 200, except that one end of the second section 212 described above is connected to a transmission line 513. Specifically, the second section 212 is ended with the transmission line 513. The resulting structure may be of 7 mm×8 mm in size and the simulation and experimental data show that it has a bandwidth about 80 MHz with its Return Loss less than −10 dB.

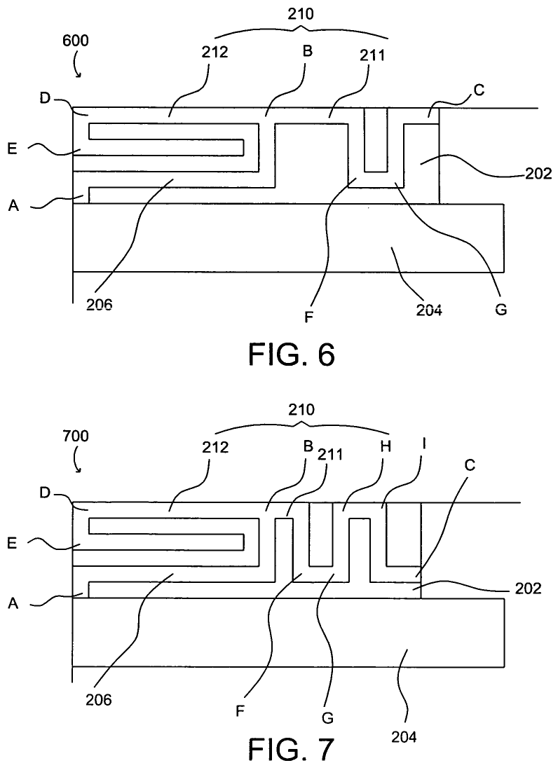

Furthermore, in one embodiment of the present invention, the first section described above may wind, such as a compact PCB antenna 600 as shown in FIG. 6 where the first section 211 has two turns, i.e. point F and point G. The resulting structure may be of 3 mm×17.5 mm in size and the simulation and experimental data show that it has a bandwidth about 130 MHz with its VSWR less than 3:1 and 70 MHz with its Return Loss less than −10 dB. If the first section 211 has more turns, such as the structure shown in FIG. 7 where the first section turn its direction four times at point F, G, H and I. The compact PCB antenna 700 may further reduce its size to 3 mm×15 mm and the bandwidth of the compact PCB antenna 700 becomes about 70 MHz with its Return Loss less than −10 dB.

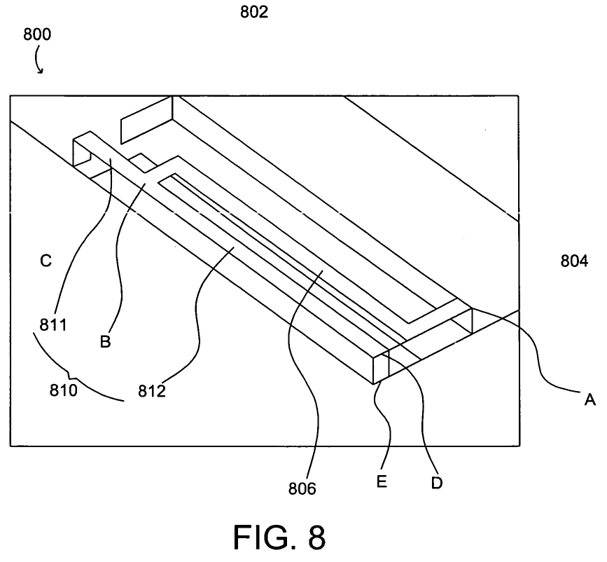

Now referring to FIG. 8, it is a perspective view of a compact PCB antenna 800 in accordance with one embodiment of the present invention. The compact PCB antenna 800 includes a substrate 802, such as FR4, FR408, or Rogers 4003 as known to those skilled in the art, a radiating element 810 patterned on the substrate 802, a ground 804 on the substrate 802, and a shorting path 806 patterned on the substrate 802. One end of the shorting path 806 is electrically connected to the ground 804 at point A and the other end of the shorting path 806 is electrically connected to the radiating element 810 at a branch point, namely point B. The point B defines a first section 811 and a second section 812 of the radiating element 810. The first section 811 has a feed pin at one end of the first section 811 at point C and the second section 812 extends to a bottom layer of other layer of the substrate 802 through a via hole. The second section 812 passes through the via hole to form two turns at point D and point E. The shorting path 806 between the radiating element 810 and the ground 804 surrounds a part of the second section 812 and electrically connects to the ground 804. In the embodiment of FIG. 8, the second section 812 is ended with a metal plane. While in another embodiment, the second section 812 may end with a transmission line. The structure of FIG. 8 may be of 3 mm×11 mm in size and the simulation and experimental data show that it has a bandwidth about 60 MHz with its Return Loss less than −10 dB.

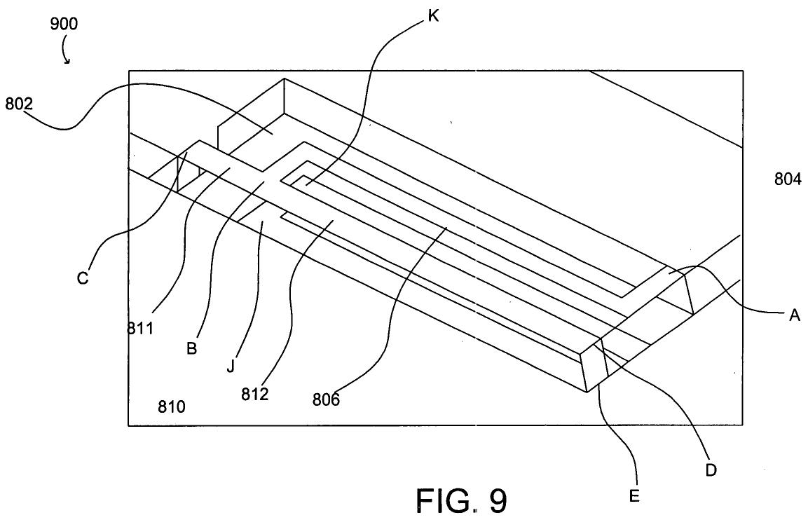

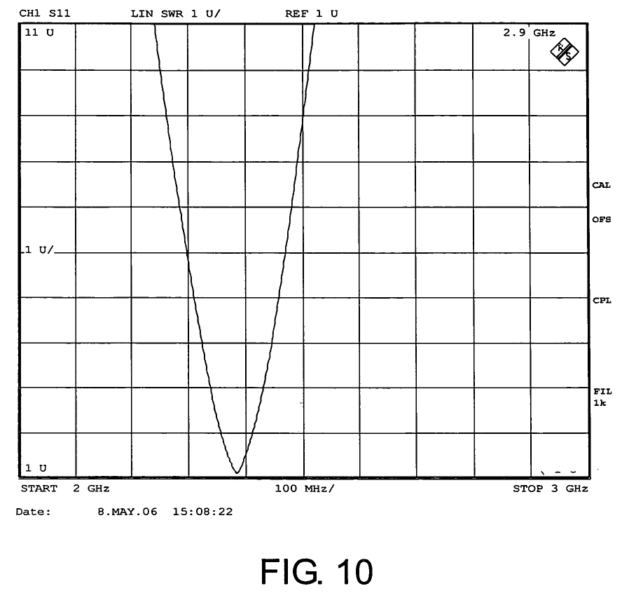

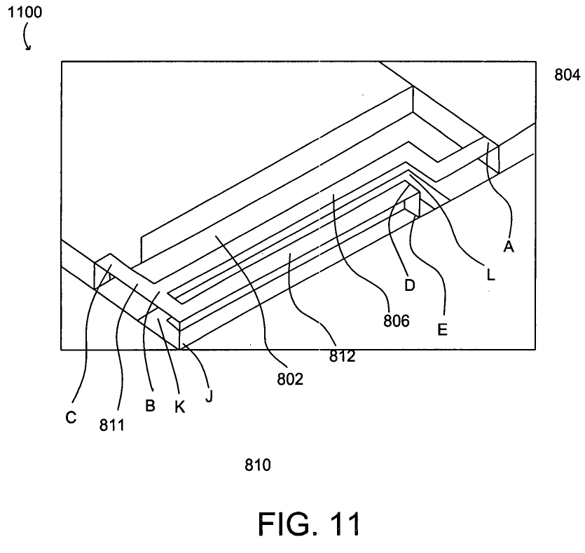

In another embodiment shown in FIG. 9, a second section 812 of a compact PCB antenna 900 extends to a bottom or other layer of the substrate 802 and further has two turns at point J and point K on the bottom layer of the substrate 802. The resulting structure may be of 2.5 mm×10 mm in size. The experimental result is presented in FIG. 10. From the curve shown in FIG. 10, the compact PCB antenna 900 has a bandwidth about 55 MHz with its Return Loss less than −10 dB.

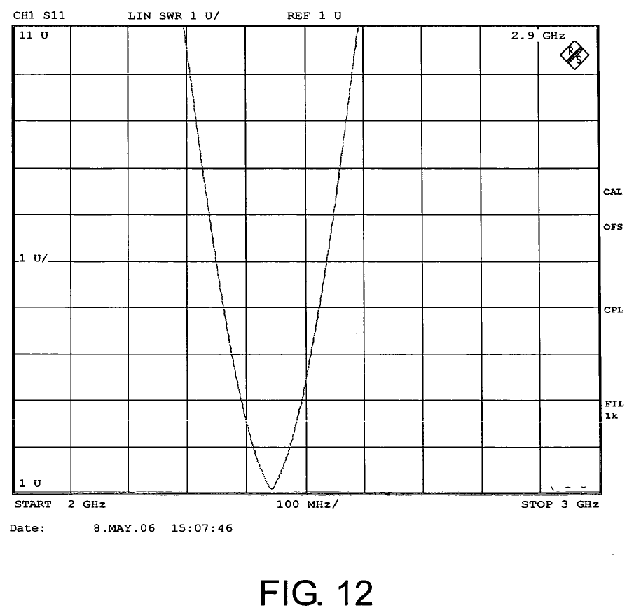

Furthermore, if we define each substrate has a pair of long sides and a pair of short sides, the radiating elements of the compact PCB antennas 200, 400, 500, 600, 700, 800, 900 may substantially extend in a first direction parallel to the long side of the substrate, and the radiating elements of the PCB antennas 200, 400, 500, 600, 700, 800, 900 may also substantially extend in a second direction parallel to the short side of the substrate. For example, in one embodiment shown in FIG. 11, a radiating element 810, or more specially, a second section 812 of a compact PCB antenna 1100 extends to a bottom layer of the substrate 802 and further has three turns at point J, point K and point L on the bottom layer of the substrate 802. Notably, the second section 812 in this embodiment extends in the second direction instead of the first direction. Explicitly, the “second direction” is contrast to the embodiments described above where the second section substantially extends in the “first direction”. The resulting structure is of 3 mm×10 mm in size and the experimental result is presented in FIG. 12. From the curve shown in FIG. 12, the compact PCB antenna 1100 reaches a good impedance matching.

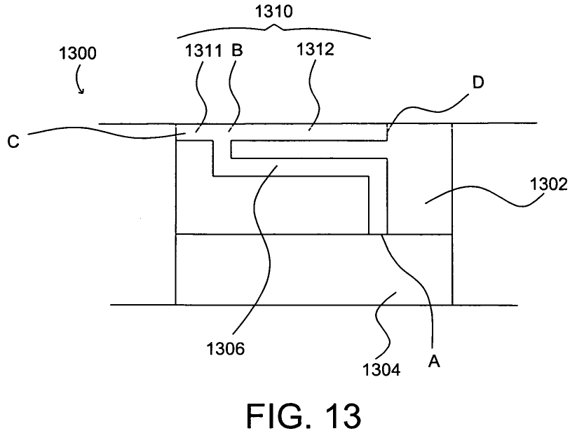

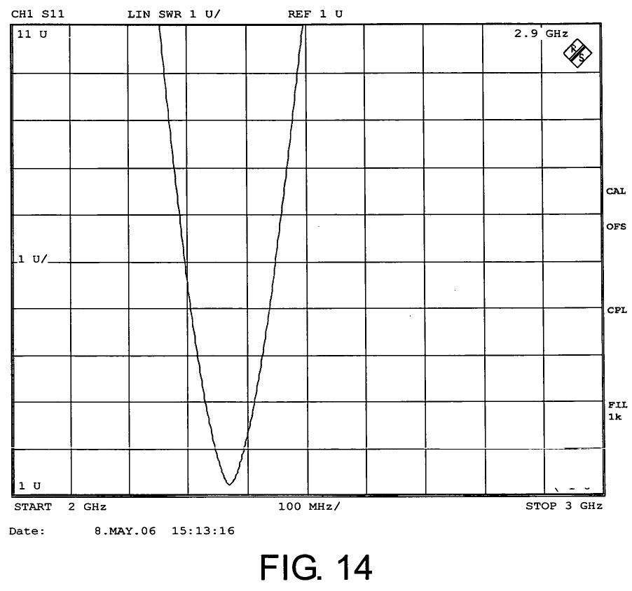

No matter extending in the first direction or in the second direction, all of the grounds, the radiating elements, and the shorting paths described above are located around a corner of the substrates. However, the grounds, the radiating elements, and the shorting paths of the present invention can also locate along a side, i.e. a long side or a short side of a substrate. For instance, FIG. 13 shows a top view of a compact PCB antenna 1300 that includes a substrate 1302, such as FR4, FR408, or Rogers 4003 as known to those skilled in the art, a radiating element 1310 patterned on the substrate 1302, a ground 1304 on the substrate 1302, and a shorting path 1306. One end of the shorting path 1306 is electrically connected to the ground 1304 at point A and the other end of the shorting path 1306 is electrically connected to the radiating element 1310 at a branch point, namely point B. The point B defines a first section 1311 and a second section 1312 of the radiating element 1310. The first section 1311 has a feed pin at one end of the first section 1311 at point C and the second section 1312 extends to the bottom or other layer of the substrate 1302 (not shown) through a via hole. The second section 1312 passing through the via hole forms a plurality of turns (not shown). The shorting path 1306 between the radiating element 1310 and the ground 1304 surrounds a part of the second section 1312. The resulting structure of FIG. 13 may be of 3 mm×12 mm in size and the experimental result is presented in FIG. 14.

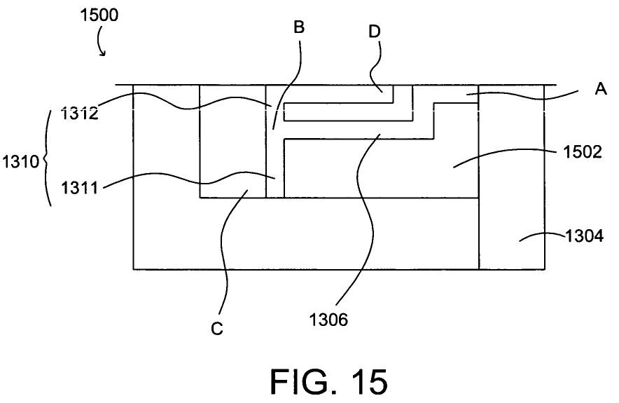

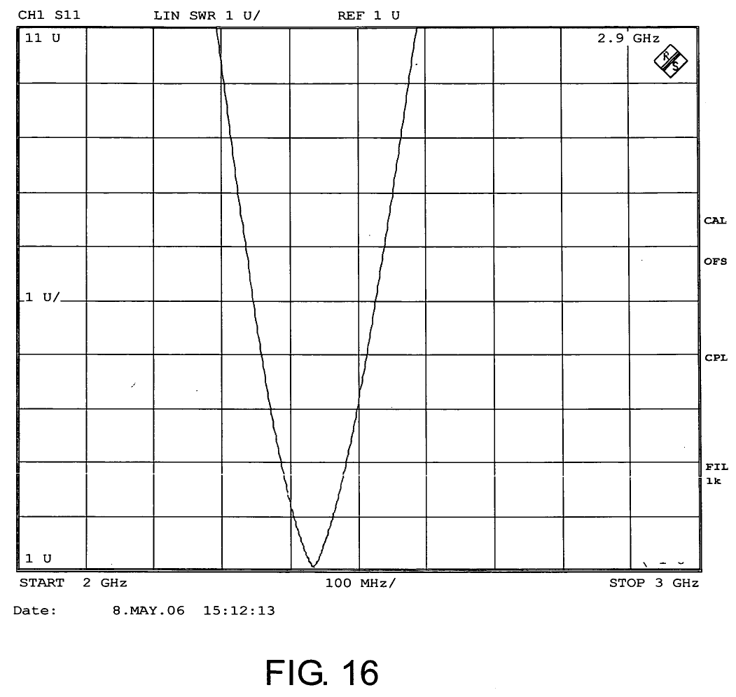

FIG. 15 shows a compact PCB antenna 1500 located along a side, i.e. a long side or a short side of a substrate 1502. Comparing to the compact PCB antenna 1300 shown in FIG. 13, the locations of the feed pin and the short pin on the substrate 1502 are different from that on the substrate 1302. Therefore, the structure is adjusted in response to the change of the locations of the feed pin and the short pin. The changed structure may be of 3.5 mm×12 mm in size and the experimental result is presented in FIG. 16.

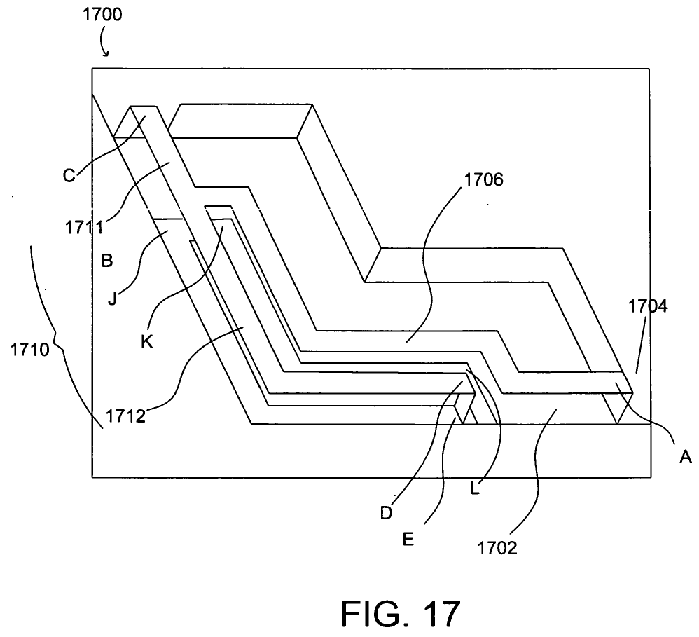

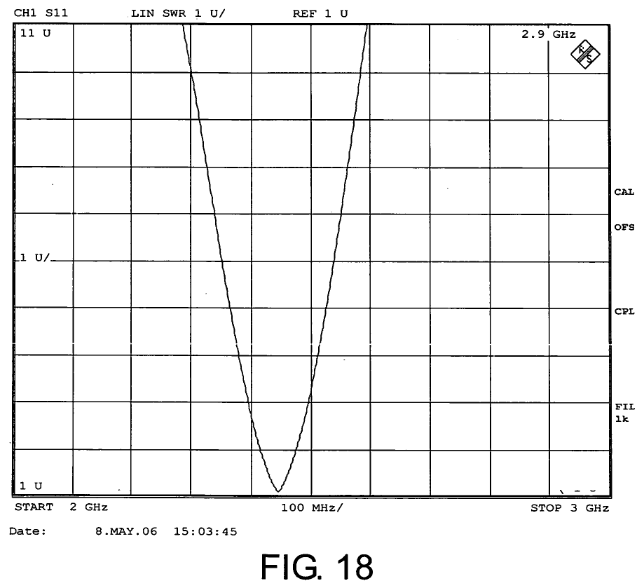

What is more, if an antenna cannot but occupy space with irregular polygon shaped, such as L shape as shown in FIG. 17, then the antenna can be designed as follows. FIG. 17 is a perspective view of a compact PCB antenna 1700 in accordance with one embodiment of the present invention. The compact PCB antenna 1700 includes a substrate 1702, such as FR4, FR408, or Rogers 4003 as known to those skilled in the art, a radiating element 1710 patterned on the substrate 1702, a ground 1704 on the substrate 1702, and a shorting path 1706 patterned on the substrate 1702. One end of the shorting path 1706 is electrically connected to the ground 1704 at point A and the other end of the shorting path 1706 is electrically connected to the radiating element 1710 at a branch point, namely point B. The point B defines a first section 1711 and a second section 1712 of the radiating element 1710. The first section 1711 has a feed pin at one end of the first section 1711 at point C and the second section 1712 extends to the bottom or other layer of the substrate 1702 through a via hole. The second section 1712, passing through the via hole, forms two turns at point D and point E. The shorting path 1706 between the radiating element 1710 and the ground 1704 surrounds a part of the second section 1712. In this embodiment, the second section 1712 extends both in the first direction and the second direction as defined above to fit the area and further includes three turns at point J, point K and point L on the bottom or other layer of the substrate 1702. The structure of FIG. 17 may be of 7 mm×7 mm in size and the experimental result is presented in FIG. 18.

The present invention has been described above with reference to preferred embodiments. However, those skilled in the art will understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

What is claimed is:

1. A compact PCB (printed circuit board) antenna, comprising:
a substrate;
a ground on the substrate;
a radiating element patterned on the substrate; and
a shorting path patterned on the substrate, the shorting path extending from a branch point of the radiating element;
wherein the branch point defines a first section and a second section of the radiating element, and the first section has a feed pin at one end of the first section and the second section winds;
and wherein the shorting path between the radiating element and the ground surrounds a part of the second section and connects to the ground.

2. The compact PCB antenna of claim 1, wherein one end of the second section is ended with a metal plane.

3. The compact PCB antenna of claim 1, wherein one end of the second section is ended with a transmission line.

4. The compact PCB antenna of claim 1, wherein the first section winds.

5. The compact PCB antenna of claim 5, wherein the first section winds by means of a plurality of turns.

6. The compact PCB antenna of claim 1, wherein the ground, the radiating element and the shorting path are on a top layer of the substrate.

7. The compact PCB antenna of claim 7, wherein the substrate has a via hole and the second section extends to a bottom layer of the substrate through the via hole.

8. The compact PCB antenna of claim 8, wherein the second section has a plurality of turns on the bottom layer of the substrate.

9. The compact PCB antenna of claim 1, wherein the ground, the radiating element and the shorting path are located around a corner of the substrate.

10. The compact PCB antenna of claim 1, wherein the ground, the radiating element and the shorting path are located along a side of the substrate.

11. The compact PCB antenna of claim 1, wherein the substrate has a long side and a short side, and the radiating element substantially extends in a first direction parallel to the long side, in a second direction parallel to the shirt side or in both of the first and the second directions.
